(19) United States
(12) Patent Application Publication
(10) Pub. No.: US 2006/0188739 A1
(43) Pub. Date: Aug. 24, 2006

(54) Composite formed article comprising vulcanizing rubber and thermoplastic elastomer and use thereof

(75) Inventor: Tadashi Imai, Chiba (JP)

Correspondence Address: FOLEY AND LARDNER LLP;SUITE 500, 3000 K STREET NW, WASHINGTON, DC, 20007, US

(73) Assignee: Mitsui Chemicals, Inc.

(21) Appl. No.: 10/548,870

(22) PCT Filed: Apr. 5, 2004
(86) PCT No.: PCT/JP04/04911

§ 371 Date: Sep. 14, 2005

(30) Foreign Application Priority Data
Apr. 17, 2003 (JP) 2003-112630

(51) Int. Cl. B32B 27/08

(52) U.S. Cl. 428/516; 428/31

(57) ABSTRACT

The object of the invention is to provide a vulcanized rubber molded product which upon melt bonding of olefinic thermoplastic elastomer thereto without an adhesive layer, can form a molded product having sufficient adhesion while generating matrix breakage upon release, as well as a molded composite comprising thermoplastic elastomer melt-bonded to the vulcanized rubber molded product. The vulcanized rubber molded product of the invention is a vulcanized rubber molded product used in melt-bonding to olefinic thermoplastic elastomer and containing 2 to 10 wt % olefinic resin having a crystallinity of 10% or more as determined by a differential scanning calorimeter (DSC). The molded composite of the invention is a molded composite comprising (1) a vulcanized rubber molded product containing 2 to 10 wt % olefinic resin having a crystallinity of 10% or more as determined by a differential scanning calorimeter (DSC) joined to (2) a molded product consisting of a thermoplastic elastomer containing 10 wt % or more olefinic resin having a crystallinity of 10% or more, as determined by a differential scanning calorimeter (DSC), and having a gel fraction of 30 wt % or less. The molded composite is used preferably in an interior or exterior decorative material for an automobile, particularly in a weather strip.

### TECHNICAL FIELD

The present invention relates to a composite molded product (also referred to as a molded composite) comprising thermoplastic elastomer melt-bonded to vulcanized rubber and use thereof and particularly to a composite molded product used as a corner profile joint or profile terminal part such as a weather strip, a door trim etc. in automobiles.

### BACKGROUND

Conventionally, production of a weather strip having a joint is carried out generally by cutting an extruded vulcanized molded product consisting of a rubber blend of an ethylene/propylene/non-conjugated diene terpolymer (EPDM), setting the cut product in one or both sides of a mold, injecting a rubber molding material of the same type as that of the rubber blend of EPDM into the formed cavity, and vulcanizing and molding it.

For the viewpoint of productivity, environmental compatibility and lightweight, thermoplastic elastomer (composition) not requiring the step of vulcanization is commenced to be used as the material to be molded with a mold in place of vulcanized rubber using an ethylene/propylene/non-conjugated diene terpolymer (EPDM).

Generally, the vulcanized rubber and the thermoplastic elastomer cannot be bonded to each other by vulcanization etc., and are thus formed into one piece via an adhesive, but this cannot be said to be satisfactory in respect of productivity or environmental compatibility.

As techniques of improving adhesiveness by devising the formulation of thermoplastic elastomer, there are those involving addition of polar group-containing resin to thermoplastic elastomer (for example, Japanese Patent Application Laid-Open No.2-115249, Japanese Patent Application Laid-Open No. 8-244068, Japanese Patent Application Laid-Open No. 10-324200).

There is also an art that involves adding a specific ethylene/1-octene copolymer prior to molding of thermoplastic elastomer (for example, Japanese Patent Application Laid-Open No. 9-40814).

As techniques improving adhesiveness by devising the formulation of vulcanized rubber, there is an art involving addition of fine crystalline polypropylene to conventional vulcanized rubber (see, for example, Japanese Patent Application Laid-Open No. 10-7849). However, when fine crystalline polypropylene such as a tactic polypropylene is added, the rubber elasticity of the conventional vulcanized rubber is reduced, and the resulting molded product is made sticky with time.

There are not only techniques concerning the formulations of thermoplastic elastomer and vulcanized rubber described above, but also an art that involves cutting vulcanized rubber and then embossing the cut surface to achieve an anchor effect (see, for example, Japanese Patent Application Laid-Open No. 9-118133) and an art that involves applying polyolefin resin powder onto a cut surface of vulcanized rubber (see, for example, Japanese Patent Application Laid-Open No. 6-47816).

The present invention relates to a vulcanized rubber molded product and use thereof, and particularly to a vulcanized rubber molded product preferable for fusing molding of thermoplastic elastomer used as a corner profile joint or profile terminal part such as a weather strip and a door trim in an automobile.

### SUMMARY OF THE INVENTION

The object of the present invention is to provide a vulcanized rubber molded product which upon melt bonding of thermoplastic elastomer without an adhesive layer, can form a molded product having sufficient adhesion while generating matrix breakage upon release, as well as a molded composite comprising thermoplastic elastomer melt-bonded to the vulcanized rubber molded product.

The vulcanized rubber molded product of the present invention is a vulcanized rubber molded product which is used for melt-bonding to olefinic thermoplastic elastomer and contains 2 to 10 wt % olefinic resin having a crystallinity of 10% or more as determined by a differential scanning calorimeter (DSC). The molded composite of the present invention is a molded composite comprising (1) a vulcanized rubber molded product containing 2 to 10 wt % olefinic resin having a crystallinity of 10% or more as determined by a differential scanning calorimeter (DSC) joined to (2) a molded product consisting of a thermoplastic elastomer containing 10 wt % or more olefinic resin having a crystallinity of 10% or more as determined by a differential scanning calorimeter (DSC) and having a gel fraction of 30 wt % or less. The molded composite is used preferably in an interior or exterior decorative material for an automobile, particularly in a weather strip.

### BRIEF DESCRIPTION OF DRAWINGS

FIG. 1(A) is a schematic perspective view showing one example of a weather strip for an automobile, wherein the linear part is formed from a vulcanized rubber molded product, and the corner part is formed from a thermoplastic elastomer composition, and FIG. 1(B) is a schematic perspective view showing a method of forming the corner part of the weather strip.

### BEST MODE FOR CARRYING OUT THE INVENTION

Hereinafter, the vulcanized rubber molded product of the present invention and its applications are specifically described.

Vulcanized Rubber Molded Product

The vulcanized rubber molded product according to the present invention comprises 2 to 10 wt % olefinic resin.

The term “vulcanized” in the present invention refers to formation of a crosslinked molecular reticulated structure as defined in “Kobunshi Daijiten” (Enlarged Polymer Dictionary), published in 1994 by Maruzen Co., Ltd., and the vulcanized rubber is completely crosslinked rubber.

The olefinic resin incorporated into the vulcanized rubber is an olefinic resin having a crystallinity of 10% or more as determined by a differential scanning calorimeter (DSC), and such olefinic resin includes C2 to C20, preferably C2 to C10, α-olefin homopolymers or copolymers.

Specific examples of the C2 to C20 α-olefin include ethylene, propylene, 1-butene, 1-pentene, 4-methyl-1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 3-methyl-l-butene, 3-methyl-1-pentene, 3-ethyl-1-pentene, 4-methyl-l-pentene, 4-methyl-1-hexene, 4,4-dimethyl-1-hexene, 4,4-dimethyl-1-pentene, 4-ethyl-l-hexene, 3-ethyl-1-hexene, 9-methyl-1-decene, 11-methyl-1-dodecene, 12-ethyl-1-tetradecene, and a combination thereof.

The melt flow rate (MFR; ASTM D 1238, 190° C., loading 2.16 kg) of the olefinic resin is preferably 0.01 to 500 g/10 min., more preferably 0.1 to 100 g/10 min. The [η] (intrinsicviscosity measured in decalin at 135° C.) of the olefinic resin is 0.1 to 10 dl/g, preferably 0.5 to 5 dl/g.

Specific examples of the olefinic resin include polyethylene, polypropylene, polybutene etc., and particularly, low-density polyethylene, linear low-density polyethylene and polypropylene are preferable.

Desirably, the density (ASTM D 1505) of the low-density polyethylene and linear low-density polyethylene in the present invention is 0.870 to 0.94 g/cm³, preferably 0.875 to 0.935 g/cm³, more preferably 0.880 to 0.930 g/cm³.

The low-density polyethylene and linear low-density polyethylene in the present invention have at least one endothermic peak (Tm) at 80 to 140° C., preferably 90 to 130° C., more preferably 100 to 130° C., in measurement with DSC. In the measurement with DSC, the endothermic peak was determined from an endothermic curve prepared by packaging an aluminum pan with a sample, heating it to 200° C. at a rate of 100° C./min., keeping it at 200° C. for 10 minutes, then cooling it to −150° C. at a rate of 100° C./min., and heating it at a rate of 10° C./min.

Each of the low-density polyethylene and linear low-density polyethylene is an ethylene homopolymer or a crystalline ethylene/α-olefinic copolymer consisting of ethylene and C3 to C20, preferably C3 to C8, α-olefin. When the polyethylene contains a comonomer, the content of the comonomer is as low as 25% or less based on the total.

The low-density polyethylene and linear low-density polyethylene used in the present invention are usually those having a crystallinity of 10% or more as determined by a differential scanning calorimeter (DSC). The polyethylene includes an ethylene/butene-1 copolymer, an ethylene/propylene copolymer, an ethylene/hexane copolymer, an ethylene/octene copolymer etc., and is preferably at least one member selected from low-density polyethylene and linear low-density polyethylene. For example, the polyethylene may be a blend of two or more of these copolymers or may consist of both high-density polyethylene and low-density polyethylene. It may consist of two or more kinds of low-density polyethylene and two or more kinds of linear low-density polyethylene. Although a catalyst etc. used in production of the crystalline ethylene-based polymer are not particularly limited, the polymer is produced by a general Ziegler-Natta catalyst, a metallocene catalyst or the like.

The melt flow rate (MFR; ASTM D 1238, 190° C., loading 2.16 kg) of the low-density polyethylene and linear low-density polyethylene used in the present invention is preferably 0.01 to 500 g/10 min. or less, more preferably 0.1 to 100 g/10 min., still more desirably 0.5 to 50 g/10 min.

The polypropylene used in the present invention includes a propylene homopolymer and a propylene copolymer produced by random copolymerization or block copolymerization of propylene with ethylene and/or C4 to C20 α-olefin.

Specifically, the C4 to C20 α-olefin includes the above-mentioned α-olefins. The comonomer to be copolymerized with propylene is preferably ethylene or 1-butene.

The content of a constituent unit (propylene content) derived from propylene in this propylene copolymer is usually 50 to 90% by weight, and the content of a constituent unit (comonomer content) derived from the comonomer is usually 50 to 10% by weight. The formulation of the propylene copolymer is determined by ¹³C-NMR.

Desirably, the melt flow rate (MFR; ASTM D 1238, 230° C., loading 2.16 kg) of the polypropylene is usually 0.01 to 100 g/10 min., preferably 0.1 to 80 g/10 min., more preferably 0.3 to 60 g/10 min.

The melting point (Tm) of the polypropylene, as determined by DSC, is usually 170° C. or less.

The content of the olefinic resin in the vulcanized rubber molded product is 2 to 10% by weight. The content is preferably 3 to 8% by weight, more preferably 4 to 5% by weight, based on the total weight (assumed to be 100% by weight) of the vulcanized rubber molded product.

The vulcanized rubber molded product according to the present invention is preferably based on an ethylene/α-olefin/non-conjugated polyene copolymer rubber. The α-olefin in the ethylene/α-olefin/non-conjugated polyene copolymer rubber is preferably a C3 to C20 α-olefin, and specific examples include the above-mentioned α-olefins. Among these α-olefins, C3 to C8 α-olefins, for example propylene, 1-butene, 4-methylpentene-1,1-hexene and 1-octene are particularly preferable.

Preferably, the ethylene/α-olefin/non-conjugated polyene copolymer rubber comprises (a) a unit derived from ethylene and (b) a unit derived from a C3 to C20 α-olefin, in a molar ratio of 50/50 to 90/10 [(a)/(b)] in order to give a rubber composition capable of providing a vulcanized rubber molded product excellent in resistance to heating and aging, strength properties, rubber elasticity, resistance to cold, and processability. This molar ratio is more preferably 65/35 to 90/10, still more preferably 65/35 to 85/15, further more preferably 65/35 to 80/20.

Specific examples of the non-conjugated polyene include:

linear non-conjugated dienes such as 1,4-hexadiene, 3-methyl-1,4-hexadiene, 4-methyl-1,4-hexadiene, 5-methyl-1,4-hexadiene, 4,5-dimethyl-1,4-hexadiene, 7-methyl-1,6-octadiene, 8-methyl-4-ethylidene-1,7-nonadiene, 4-ethylidene-1,7-undecadiene etc.;

cyclic non-conjugated dienes such as methyl tetrahydroindene, 5-ethylidene-2-norbornene, 5-methylene-2-norbornene, 5-isopropylidene-2-norbornene, 5-vinylidene-2-norbornene, 6-chloromethyl-5-isopropenyl-2-norbornene, 5-vinyl-2-norbornene, 5-isopropenyl-2-norbornene, 5-isobutenyl-2-norbornene, cyclopentadiene, norbornadiene etc.; and

trienes such as 2,3-diisopropylidene-5-norbornene, 2-ethylidene-3-isopropylidene-5-norbornene, 2-propenyl-2,2-norbornadiene, 4-ethylidene-8-methyl-1,7-nanodiene etc. Among these non-conjugated polyenes, 5-ethylidene-2-norbornene, 5-vinyl-2-norbornene, cyclopentadiene, and 4-ethylidene-8-methyl-1,7-nanodiene are particularly preferable.

These non-conjugated polyenes can be used alone or as a mixture of two or more thereof.

The iodine value of the ethylene/α-olefin/non-conjugated polyene copolymer is preferably 1 to 40, more preferably 1 to 30, in respect of an advantage in cost and in order to give a rubber composition of high crosslinking efficiency to provide a vulcanized rubber molded product excellent in resistance to compressive permanent distortion.

The Mooney viscosity [ML1+4 (125° C.)] of the ethylene/α-olefin/non-conjugated polyene copolymer rubber is preferably 10 to 250, more preferably 40 to 150, in order to give a rubber composition capable of providing a vulcanized rubber molded product excellent in processability, strength properties and resistance to compressive permanent distortion. These ethylene/α-olefin/non-conjugated polyene copolymer rubbers may be used alone or as a mixture of two or more thereof.

In the vulcanized rubber, carbon black is used preferably in an amount of 30 to 300 parts by weight based on 100 parts by weight of the ethylene/α-olefin/non-conjugated polyene copolymer rubber in order to give an extrusion-molded vulcanized rubber molded product having sufficient mechanical strength.

As the carbon black, it is possible to.use carbon black such as SRF, GPF, FEF, MAF, HAF, ISAF, SAF, FT, MT etc. The nitrogen adsorption specific surface area of carbon black is preferably 10 to 100 m²/g in order to give a rubber composition capable of providing a vulcanized rubber molded product excellent in mechanical strength and product skin.

Depending on intended applications of the vulcanized product, conventionally known additives such as an antioxidant, a processing aid, a foaming agent, a foaming aid, a coloring agent, a dispersant and a flame retardant are added to the vulcanized rubber.

Depending on applications, inorganic fillers can be used suitably as a reinforcing material in the vulcanized rubber, and the amount of the inorganic fillers is usually up to 100 parts by weight based on 100 parts by weight of the ethylene/α-olefin/non-conjugated polyene copolymer rubber.

Specifically, the inorganic fillers include silica, light calcium carbonate, heavy calcium carbonate, talc, clay etc.

As the softening agent incorporated into the vulcanized rubber, a softening agent used usually in rubber can be used. Specific examples include:

petroleum-based softening agents such as process oil, lubricating oil, paraffin, liquid paraffin, polyethylene wax, polypropylene wax, petroleum asphalt, vaseline, etc.;

coal tar-based softening agents such as coal tar, coal tar pitch, etc.

fatty oil-based softening agents such as castor oil, linseed oil, grapeseed oil, soybean oil, coconut oil, etc.;

tall oil;

sub, (factis);

wax such as beeswax, carnauba wax, lanoline, etc.;

fatty acids and fatty acid salts such as ricinoleic acid, palmitic acid, stearic acid, barium stearate, calcium stearate, zinc laurate, etc.;

naphthenic acid;

pine acid, rosin or its derivatives;

synthetic polymers such as terpene resin, petroleum resin, chroman indene resin, atactic polypropylene, etc.;

ester-based softeners such as dioctyl phthalate, dioctyl adipate, dioctyl sebacate, etc.; and

microcrystalline wax, liquid polybutadiene, modified liquid polybutadiene, liquid polyisoprene, terminal-modified polyisoprene, hydrogenated terminal-modified polyisoprene, liquid Thiokol, hydrocarbon-based synthetic lubricating oil, etc. Among these compounds, petroleum softeners, particularly process oil, are preferably used. The amount of these softeners incorporated is selected suitably depending on applications of the vulcanized product.

The vulcanizing agent used in production of the vulcanized rubber includes sulfur and sulfur compounds. The vulcanized rubber includes not only rubber crosslinked with sulfur but also rubber crosslinked with another crosslinking agent.

Specifically, the sulfur includes powder sulfur, precipitated sulfur, colloidal sulfur, surface-treated sulfur, insoluble sulfur etc.

Specifically, the sulfur compounds include sulfur chloride, sulfur dichloride, high-molecular polysulfide, etc. Use can also be made of sulfur compounds releasing active sulfur at their vulcanization temperature, for example morpholine disulfide, alkyl phenol disulfide, tetramethyl thiuram disulfide, dipentamethylene thiuram tetrasulfide, selenium dimethyl dithiocarbamate, etc.

Among these, sulfur is preferable.

Sulfur or the sulfur compound is used usually in an amount of 0.1 to 10 parts by weight based on 100 parts by weight of the copolymer rubber.

When sulfur or the sulfur compound is used as the vulcanizing agent, a vulcanization accelerator is preferably simultaneously used. Specific examples of the vulcanization accelerator include:

Sulfonamide-based compounds such as N-cyclohexyl-2-benzothiazole sulfenamide (CBS), N-oxydiethylene-2-benzothiazole sulfenamide (OBS), N-t-butyl-2-benzothiazole sulfenamide (BBS), N,N-diisopropyl-2-benzothiazole sulfenamide, etc.;

thiazole-based compounds such as 2-mercaptobenzothiazole (MBT), 2-(2,4-dinitrophenyl) mercaptobenzothiazole, 2-(4-morpholinothio) benzothiazole, 2-(2,6-diethyl-4-morpholinothio) benzothiazole, dibenzothiazyl disulfide, etc.;

guanidine-based compounds such as diphenyl guanidine (DPG), triphenyl guanidine, diorthonitrile guanidine (DOTG), orthotollyl biguanide, diphenyl guanidine naphthalate, etc.;

aldehyde amine or aldehyde/ammonia-based compounds such as an acetaldehyde/aniline condensate, a butyl aldehyde/aniline condensate, hexamethylene tetramine (H), acetaldehyde ammonia, etc.;

imidazoline-based compounds such as 2-mercaptoimidazoline etc.;

thiourea-based compounds such as thiocarbanilide, diethyl thiourea (EUR), dibutyl thiourea, trimethyl thiourea, diorthotollyl thiourea, etc.;

thiuram-based compounds such as tetramethyl thiuram sulfide (TMTM), tetramethyl thiuram disulfide (TMTD), tetraethyl thiuram disulfide, tetrabutyl thiuram disulfide, tetrakis(2-ethylhexyl) thiuram disulfide (TOT), dipentamethylene thiuram tetrasulfide (TRA), etc.;

dithiocarbamates such as zinc dimethyl dithiocarbamate, zinc diethyl dithiocarbamate, zinc di-n-butyl dithiocarbamate, zinc ethylphenyl dithiocarbamate, zinc butylphenyl dithiocarbamate, sodium dimethyl dithiocarbamate, selenium dimethyl dithiocarbamate, tellurium dimethyl dithiocarbamate, etc.;

xanthogenates such as zinc dibutyl xanthogenate etc.; and

compounds such as zinc white (zinc oxide) etc.

These vulcanization accelerators are used usually in an amount of 0.1 to 20 parts by weight based on 100 parts by weight of the copolymer rubber.

The antioxidant used in the vulcanized rubber includes an amine-based antioxidant, a hindered phenol-based inhibitor and a sulfur-based inhibitor, and these antioxidants are used in such a range that the object of the present invention is not hindered.

The amine-based antioxidant includes diphenyl amines, phenylene diamines, etc.

As the sulfur-based antioxidant, a sulfur-based antioxidant used usually in rubber is used.

As the processing aid, a processing aid used usually in rubber is used. Specific examples include higher fatty acids such as linoleic acid, ricinoleic acid, stearic acid, palmitic acid, lauric acid etc., higher fatty acid salts such as barium stearate, zinc stearate, calcium stearate, etc., and esters of these higher fatty acids.

These processing aids are used usually in an amount of 10 parts by weight or less based on 100 parts by weight of the ethylene/α-olefin/non-conjugatedpolyene copolymer rubber, but desirably the optimum amount is determined depending on required physical values.

Specific examples of the foaming agent include inorganic foaming agents such as sodium bicarbonate (baking soda), sodium carbonate, ammonium bicarbonate, ammonium carbonate, ammonium nitrite, etc.; nitroso compounds such as N,N′-dimethyl-N,N′-dinitrosoterephthalamide, N,N′-dinitrosopentamethylene tetramine (DPT), etc.; azo compounds such as azodicarbonamide (ADCA), azobisisobutyronitrile (AZBN), azobiscyclohexyl nitrile, azodiaminobenzene, barium azodicarboxylate, etc.; sulfonyl hydrazide compounds such as benzene sulfonyl hydrazide (BSH), toluene sulfonyl hydrazide (TSH), p,p′-oxybis (benzene sulfonyl hydrazide) (OBSH), diphenylsulfone-3,3′-disulfonyl hydrazide, etc.; and azide compounds -such as calcium azide, 4,4-diphenyl disulfonyl azide, p-toluene sulfonyl azide, etc.

Known other rubber can also be used by blending it with the components of the vulcanized rubber. The other rubber includes natural rubber (NR), isoprene-based rubber such as isoprene rubber (IR) etc., and conjugated diene-based rubber such as butadiene rubber (BR), styrene/butadiene rubber (SBR), acrylonitrile/butadiene rubber (NBR), chloroprene rubber (CR) etc.

[Preparation of the Rubber Composition and its Vulcanized Rubber Molded Product]

The rubber composition used in preparation of the vulcanized rubber molded product can be prepared by kneading ethylene/α-olefin/non-conjugated polyene copolymer rubber, carbon black, a rubber-reinforcing agent, an inorganic filler and additives such as a softening agent at a temperature of 80 to 170° C. for 2 to 20 minutes in an internal mixer (mixer in a closed system) such as a Banbury mixer, a kneader or an intermix, then adding and mixing a vulcanizing agent such as sulfur and if necessary a vulcanization accelerator, a vulcanization aid, a foaming agent and a foaming aid by using a roll such as an open roll or a kneader, kneading the mixture at a roll temperature of 40 to 80° C. for 5 to 30 minutes, and dispensing it.

The rubber composition for extrusion molding, prepared in the manner described above, is formed into an intended shape by an extrusion molding machine, and simultaneously with this molding or after introduction of the molded product into a vulcanization bath, is vulcanized by heating at a temperature of 140 to 300° C. for 1 to 20 minutes.

Usually, the vulcanization process is conducted continuously. In the heating method in the vulcanization bath, a heating means such as hot air, a glass beads fluidized bed, liquid curing medium, (LCM), PCM (powder curing medium or powder curing method), UHF (ultra high frequency) or steam can be used.

The vulcanized rubber molded product of the present invention has been gelled, and cannot be measured for fluidity (for example MFR) even after milling of the molded product.

Olefinic Thermoplastic Elastomer

The “olefinic thermoplastic elastomer” according to the present invention refers to a thermoplastic elastomer consisting of olefinic resin and olefinic rubber.

The thermoplastic elastomer has physical properties similar to those of rubber, for example flexibility and impact resilience, and can be processed as thermoplastics in contrast to conventional rubber, and such explanation appears in, for example, “Kobunshi Daijiten” (Enlarged Polymer Dictionary), published in 1994 by Maruzen Co., Ltd.

The content of the olefinic resin in the thermoplastic elastomer according to the present invention is higher than 10% by weight, and is preferably 15 to 70% by weight, more preferably 20 to 60% by weight.

The thermoplastic elastomer used in the present invention is a thermoplastic elastomer forming a morphology of islands-sea structure wherein the average particle diameter of the island phase is 2 μm or less. The island phase is composed mainly of a crosslinked (gelled) component. The island s-sea structure refers to a phase structure having dispersed particles in matrix. The average particle diameter of the island phase can be determined by measuring a sample sampled arbitrarily from a photograph magnified 10,000-times under a transmission electron microscope. The average particle diameter of the island phase was expressed specifically in terms of the average of the minor axis and major axis (that is, the average of (minor axis+major axis)/2) of every island phase in an electron microphotograph.

The gel fraction of the thermoplastic elastomer of the present invention is 30% by weight or less.

The gel fraction of the thermoplastic elastomer according to the present invention is preferably 20% by weight or less, more preferably 10% by weight or less. The lower limit is not particularly limited and may be 0% by weight, that is, no crosslinked product may be contained. The method of measuring the gel fraction is as follows.

[Method of Measuring the Gel Fraction]

About 100 mg thermoplastic elastomer pellets were weighed out as a sample, wrapped with a 325-mesh screen, and dipped at 140° C. for 24 hours in p-xylene in an amount (30 ml) enough for the pellets in a closed container.

Then, this sample was taken out on a filter paper and dried at 80° C. for 2 hours or more until the weight of the sample became constant. The gel fraction is expressed by the following equation:
Gel fraction[wt %]=[dry weight of the sample after dipping in p-xylene/weight of the sample before dipping in p-xylene]×100

The content of the non-crosslinked ethylene-based component (ethylene-based resin -or ethylene-based rubber) in the thermoplastic elastomer according to the present invention is preferably 5 to 40% by weight, more preferably 10 to 35% by weight, still more preferably 15 to 30% by weight. The content of the non-crosslinked ethylene-based component (ethylene-based resin, ethylene-based rubber) can be determined from gel fraction. In the olefinic thermoplastic elastomer in the present invention, the sea phase is a non-crosslinked component and the island phase is a crosslinked component in many cases.

The ethylene-based resin component includes high-density, polyethylene, low-density polyethylene, linear low-density polyethylene etc. As the ethylene-based rubber component, ethylene/propylene rubber, ethylene/butene-1 copolymer rubber, ethylene/hexene-1 copolymer rubber, ethylene/octene-1 copolymer rubber and ethylene/propylene/butene-1 copolymer rubber are particularly preferable. When such thermoplastic elastomer is melt-bonded to the vulcanized rubber molded product described above, breakage of the matrix easily occurs upon release by pulling.

Then, the method of producing the olefinic thermoplastic elastomer according to the present invention is described.

The olefinic thermoplastic elastomer of the present invention is obtained by dynamic heat-treatment of a blend consisting of olefinic resin and olefinic rubber in the presence or absence of a crosslinking agent.

The olefinic thermoplastic elastomer of the present invention may also be obtained by dynamically heat-treating a blend consisting of olefinic resin and olefinic rubber in the presence or absence of a crosslinking agent, then adding non-crosslinked olefinic resin and/or an olefinic rubber component (preferably the above-mentioned ethylene-based component) to the resulting thermoplastic elastomer, and then dynamically heat-treating the mixture.

The ratio of the olefinic resin to the olefinic rubber compounded as the starting material can be determined suitably such that the content of the olefinic resin in the finally obtained olefinic thermoplastic elastomer composition is higher than 10% by weight.

In the thermoplastic elastomer of the present invention, the amount of the olefinic resin having a crystallinity of 10% or more as determined by a differential scanning calorimeter (DSC) is determined by a differential scanning calorimeter (DSC) from the weight of a polymer obtained by extracting the thermoplastic elastomer in boiling xylylenel and precipitating its soluble fraction in methyl ethyl ketone.

The amount of the crosslinking agent used and the amount of the non-crosslinked olefinic resin and/or olefinic rubber component added after crosslinkage can be regulated to achieve the desired gel fraction and the content of the non-crosslinked ethylene-based component.

[Olefinic Resin]

The olefinic resin serving as a starting material of the thermoplastic elastomer of the present invention has a crystallinity of 10% or more as determined by a differential scanning calorimeter (DSC).

The melt flow rate (MFR; ASTM D 1238, 190° C., loading 2.16 kg) of the olefinic resin is preferably 0.01 to 500 g/10 min., more preferably 0.1 to 100 g/10 min.

The olefinic resin of the present invention includes a C2 to C20, preferably C2 to C10, α-olefin homopolymer or copolymer. The α-olefin includes the same α-olefins as described above. The olefinic resin includes polyethylene, polypropylene, polybutene etc., among which low-density polyethylene, linear low-density polyethylene, high-density polyethylene, and polypropylene are particularly preferable. As the low-density polyethylene, linear low-density polyethylene and polypropylene, the same low-density polyethylene, linear low-density polyethylene and polypropylene as described above in the item of the olefinic resin added to the vulcanized rubber can be used.

The density (ASTM D 1505) of the high-density polyethylene is higher than 0.94 g/cm³, and is preferably 0.945 to 0.980 g/cm³, more preferably 0.950 to 0975 g/cm³.

This high-density polyethylene is an ethylene homopolymer or a crystalline ethylene/α-olefinic copolymer consisting of ethylene and a C3 to C20, preferably C3 to C8, α-olefin. When a comonomer is contained, the content of the comonomer is as small as 25 mol % or less based on the total.

Specific examples include an ethylene/butene-1 copolymer, an ethylene/propylene copolymer, an ethylene/octene copolymer, etc.

[Olefinic Rubber]

The olefinic rubber serving as a starting material of the thermoplastic elastomer of the present invention has a crystallinity of less than 10% as determined by a differential scanning calorimeter (DSC). The olefinic rubber in the present invention is an amorphous random elastic copolymer containing at least 50 mol % C2 to C20 α-olefin, and examples thereof include a non-crystalline α-olefin copolymer consisting of 2 or more kinds of α-olefins and an α-olefin/non-conjugated diene copolymer consisting of 2 or more kinds of α-olefins and non-conjugated dienes.

Specific examples of the olefinic copolymer rubber include the following rubber:
(1) Ethylene/α-olefin copolymer rubber [ethylene/α-olefin (molar ratio)=90 to 50/10 to 50 wherein the total of ethylene and α-olefin is assumed to be 100].
(2) Ethylene/α-olefin/non-conjugated diene copolymer rubber [ethylene/α-olefin/non-conjugated diene (molar ratio)=90 to 50/10 to 50/0.1 to 10 wherein the total of ethylene, α-olefin and non-conjugated diene is assumed to be 100].

Specific examples of the α-olefin include the α-olefins described above.

Specific examples of the non-conjugated diene include the above-described non-conjugated dienes, among which dicyclopentadiene, 1,4-hexadiene, cyclooctadiene, methylene norbornene, and ethylidene norbornene are preferable.

The Mooney viscosity [ML1+4 (100° C.)] of the copolymer rubber is preferably 10 to 250, particularly 40 to 150. The iodine value of the ethylene/(α-olefin/non-conjugated diene copolymer rubber (2) is preferably 25 or less.

Among the olefinic copolymer rubbers described above, ethylene/propylene/non-conjugated diene rubber is particularly preferably used.

The rubber used in the present invention includes not only the above-mentioned olefinic copolymer rubber but also rubber other than the olefinic copolymer rubber, for example diene-based rubber such as styrene/butadiene rubber (SBR), nitrile rubber (NBR), natural rubber (NR) and butyl rubber (IIR), SEBS, polyisobutylene, etc.

[Crosslinking Agent]

The crosslinking agent used in the present invention includes, for example, organic peroxides, sulfur, sulfur compounds, and phenol-based vulcanizing agents such as phenol resin, among which the organic peroxides are preferably used.

Specific examples of the organic peroxides include dicumyl peroxide, di-tert-butyl peroxide, 2,5-dimethyl-2,5-di(tert-butylperoxy) hexane, 2,5-dimethyl-2,5-di(tert-butylperoxy) hexyne-3,1,3-bis(tert-butylperoxy isopropyl) benzene, 1,1-bis(tert-butylperoxy)-3,3,5-trimethyl cyclohexane, n-butyl-4,4-bis(tert-butylperoxy) valerate, benzoyl peroxide, p-chlorobenzoyl peroxide, 2,4-dichlorobenzoyl peroxide, tert-butyl peroxybenzoate, tert-butyl perbenzoate, tert-butyl peroxyisopropyl carbonate, diacetyl peroxide, lauroyl peroxide, tert-butyl cumyl peroxide, etc.

Among these compounds, 2,5-dimethyl-2,5-di(tert-butylperoxy) hexane, 2,5-dimethyl-2,5-di(tert-butylperoxy) hexyne-3, 1,3-bis(tert-butylperoxyisopropyl) benzene, 1,1-bis(tert-butylperoxy)-3,3,5-trimethylcyclohexane and n-butyl-4,4-bis(tert-butylperoxy) valerate are preferable in respect of smell and scorch stability, among which 1,3-bis (tert-butylperoxyisopropyl) benzene ismost preferable.

This organic peroxide is used in an amount of 0.01 to 0.4 part by weight, preferably about 0.03 to 0.3 part by weight, based on 100 parts by weight of the olefinic resin and olefinic rubber in total.

In crosslinking treatment with the organic peroxide in the present invention, it is possible to incorporate a crosslinking aid such as sulfur, p-quinone dioxime, p,p′-dibenzoyl quinonedioxime, N-methyl-N,4-dinitrosoaniline, nitrobenzene, diphenyl guanidine or trimethylol propane-N,N′-m-phenylene dimaleimide, divinyl benzene, triallyl cyanurate, a multifunctional methacrylate monomer such as ethylene glycol dimethacrylate, diethylene glycol dimethacrylate, polyethylene glycol dimethacrylate, trimethylol propane trimethacrylate or allyl methacrylate, or a multifunctional vinyl monomer such as vinyl butyrate or vinyl stearate. Given these compounds, uniform and gentle crosslinking reaction can be expected. Particularly in the present invention, divinyl benzene is most preferable because it is easily handled, is excellent in compatibility with the olefinic resin or olefinic rubber as the material to be treated, and has an action of solubilizing organic peroxides to act as a dispersing agent for the organic peroxides, thus attaining a uniform crosslinking effect by heat treatment to give a, composition having good balance between fluidity and physical properties.

It is preferable in the present invention that the amount of such crosslinking aids or multifunctional vinyl monomers incorporated is usually in the range of 0.01 to 0.4 wt %, particularly 0.03 to 0.3 wt %, based on 100 parts by weight of the olefinic resin and olefinic rubber in total.

[Other Components]

Additives such as a softening agent, a slip agent, a filler, an antioxidant, a weathering stabilizer and a coloring agent can be incorporated into the olefinic thermoplastic elastomer according to the present invention if necessary in such a range that the object of the present invention is not hindered.

Now, dynamic heat-treatment is described. The “dynamically heat-treating” refers to kneading in a molten state (this applies hereinafter).

The dynamic heat-treatment in the present invention is conducted preferably in an apparatus in a closed system, and conducted preferably in an atmosphere of an inert gas such as nitrogen, carbon dioxide gas, etc.

The kneading temperature is usually 150 to 280° C., preferably 170 to 240° C. The kneading time is usually 1 to 20 minutes, preferably 3 to 10 minutes. Applied shear force, in terms of shear rate, is 10 to 100,000 sec⁻¹, preferably 100 to 50,000 sect⁻¹.

As the kneading apparatus, a mixing roll, an intensive mixer (for example a Banbury mixer, a kneader) or a single- or twin-screw extruder is used, and the apparatus is preferably in a closed system.

The melt flow rate (MFR; ASTM D 1238, 230° C., loading 2.16 kg) of the thus obtained olefinic thermoplastic elastomer according to the present invention is usually 0.01 to 1000 g/10 min., preferably 0.05 to 500 g/10 min., more preferably 0.1 to 100 g/10 min. The thermoplastic elastomer having a melt flow rate in the above range is excellent in moldability.

Molded Composite

The molded composite according to the present invention comprises an olefinic thermoplastic elastomer joined to, preferably melt-bonded to, the vulcanized rubber molded product.

The adhesion of a joint of the molded composite according to the present invention, in terms of peel strength in a peel strength test described later, is 40 MPa or more, preferably 45 MPa or more, and interfacial release is hardly observed, and the degree of breakage of the matrix is 80% or more, preferably 90% or more.

The composite molded product consisting of the vulcanized rubber molded product and thermoplastic elastomer according to the present invention is used preferably in an interior or exterior decorative material for an automobile, particularly preferably in a weather strip for an automobile. The vulcanized rubber molded product according to the present invention is not limited to a weather strip, and can be used in other applications requiring adhesion to thermoplastic elastomer.

In the present invention, the weather strip material means a sealing material for an automobile, and includes a door weather strip, a bonnet weather strip, a glass run channel, etc.

Specifically, in molding of a corner wherein the extruded molded product of vulcanized rubber is cut and the resulting cut extruded molded products are connected to each other in different directions, a weather strip can be obtained by injection-molding the olefinic thermoplastic elastomer at a temperature of not lower than its melting point and then melt-bonding the injection-molded elastomer, by contacting, to the extruded molded products of vulcanized rubber.

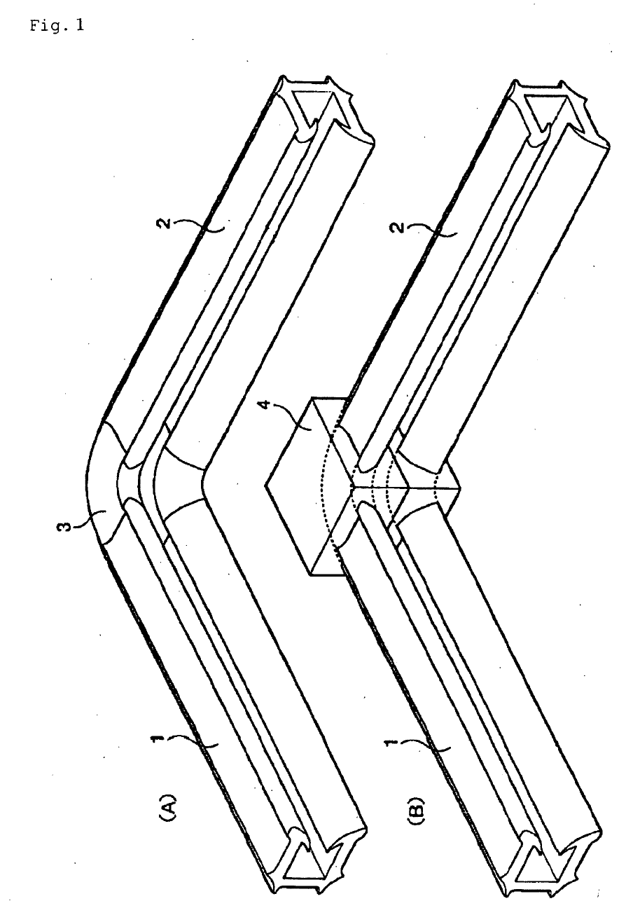

The weather strip having a corner molded product consisting of the vulcanized rubber molded product and olefinic thermoplastic elastomer according to the present invention is described more specifically by reference to FIG. 1.

FIG. 1 is a schematic perspective view showing a weather strip (glass run channel) for an automobile and a method of forming the same.

As shown in FIG. 1(A), the weather strip is composed of cut extruded molded products 1 and 2 made of vulcanized rubber and a connecting corner member 3 formed upon connecting the cut extruded molded products 1 and 2 to each other in different directions. The cut extruded molded products 1 and 2 are those obtained by injection-molding the vulcanized rubber in a channel form and then cut it in predetermined length. The cut extruded molded products 1 and 2 have a linear shape in the longer direction. As used herein, the “connecting corner member” refers to the portion made of thermoplastic elastomer which is formed upon connecting the cut extruded molded products to each other in different directions.

The weather strip can be prepared in the following manner. First, a mold 4 for injection molding is previously heated to a predetermined temperature. As shown in FIG. 1(B), the cut extruded molded products land 2 made of vulcanized rubber are then inserted into the mold 4.

Though not shown in the figure, the olefinic thermoplastic elastomer molten at a temperature not lower than its melting point in a heating chamber (in a screw) is then injected into a space formed between the cavity of mold 4 and the core, and the olefinic thermoplastic elastomer molten at a temperature not lower than its melting point is melt-bonded to the edge faces of the cut extruded molded products 1 and 2, followed by cooling the thermoplastic elastomer, to give the weather strip having a corner member 3 as shown in FIG. 1(A).

### EXAMPLES

Hereinafter, the present invention is described in more detail by reference to the Examples, but the present invention is not limited to these examples.

Measurement or evaluation of the hardness, tensile strength and elongation of the vulcanized rubber molded product used in each of the Examples and Comparative Examples, the melting point (Tm) of the polyethylene and polypropylene used in each of the Examples and Comparative Examples, and the melt flow rate (MFR), hardness, tensile strength, elongation, and released form upon release by pulling, of the olefinic thermoplastic elastomer used in each of the Examples and Comparative Examples was conducted according to the following methods.

(1) Hardness

Shore A hardness was measured in accordance with JIS K6301. Measurement conditions: A sheet was prepared by a pressing molding machine, and using an A-type measuring instrument, the scale was read just after a probe was contacted by pushing.

(2) Tensile Strength and Elongation

According to JIS K6301, a tensile test was conducted under the following conditions to determine tensile strength and elongation at breakage.

Test conditions: A sheet was prepared by a pressing molding machine, and a test specimen JIS3 was punched out and examined under the condition of a stress rate of 200 mm/min.

(3) Melt Flow Rate (MFR)

The melt flow rate of the olefinic thermoplastic elastomer was measured at 230° C. under a loading of 2.16 kg in accordance with ASTM D 1238-65T.

(4) Tensile Peel Strength and Form of Breakage Upon Release Will be Described Later.

### Reference Example 1

Preparation of Vulcanized Rubber Press Sheet

A rubber composition (hereinafter referred to as EPT-1) containing 20 parts by weight of block PP (MFR at 230° C. under a loading of 2.16 kg=35 g/10 min., Tm=161° C., ethylene amount 5.6 wt %) contained in 100 parts by weight of oil-extended ethylene/propylene/5-ethylidene-2-norbornene copolymer rubber (ethylene content, 68 mol %; propylene content, 32 mol %; iodine value, 12; Mooney viscosity [ML₁₊₄ (125° C.)], 63; the amount of an oil extender, 10 parts by weight of paraffin-based process oil (trade name: PW-380, manufactured by Idemitsu Kosan Co., Ltd.) based on 100 parts by weight of the rubber) was used as starting rubber. 130 parts by weight of the starting rubber EPT-1, 165parts by weight of FEF-grade carbon black [tradename: Asahi #60G, manufactured by Asahi Carbon Co., Ltd.], 30 parts by weight of calcium carbonate [trade name: Whiton SB, manufactured by Shiraishi Calcium Co., Ltd.], 82 parts by weight of a softening agent [trade name: PW-380, manufactured by Idemitsu Kosan Co., Ltd.], 1 part by weight of stearic acid, 5 parts by weight of. zinc white No. 3, and 5 parts by weight of calcium oxide [trade name: VESTA-BS, manufactured by Inoue Sekkai Kogyo Co., Ltd.] were kneaded in a 1.7-L Banbury mixer [BB-2 type mixer, manufactured by Kobe Steel, Ltd.].

In kneading, the starting rubber was kneaded for 1 minute and then carbon black, calcium carbonate, the softening agent, stearic acid, zinc white No. 3, and the activating agent were added thereto and kneaded for 2 minutes. Thereafter, a ram was raised and cleaned, and the mixture was kneaded for additional 2 minutes to give 1670 g rubber blend (I). This kneading was conducted at a packing of 75%, and by the same operation, 3 batches were kneaded to give 5010 g blend in total.

3670 g of the resulting rubber blend (I) was weighed out, wound on a 14-inch roll (manufactured by Nippon Roll MFG Co., Ltd.) (surface temperature of a former roll, 60° C.; surface temperature of a latter roll, 60° C.; number of revolutions of the former roll, 16 rpm; number of revolutions of the latter roll, 18 rpm), and 1.5 parts by weight of sulfur, 0.5 part by weight of 2-mercaptobenzothiazole [trade name: Sunseller M, manufactured by Sanshin Chemical Industry Co., Ltd.] and 1.0 part by weight of tetramethyl thiuram disulfide [trade name: Sunseller TT, manufactured by Sanshin Chemical Industry Co., Ltd.] were added to the rubber blend (I) and kneaded for 7 minutes with a 14-inch open roll (roll temperature 60° C., manufactured by Nippon Roll MFG Co., Ltd.) to give a rubber blend (II).

The rubber blend (II) was vulcanized and molded by heating at 170° C. for 10 minutes with a 150-ton press to produce a flat plate of 12 cm in length, 14.7 cm in width and 2 mm in thickness. A vulcanized press sheet (referred to hereinafter as vulcanized rubber molded product 1) was obtained in this manner.

### Reference Example 2

15 parts by weight of high-density polyethylene [density (ASTM D 1505), 0.956 g/cm³; MFR (ASTM D 1238, 190° C., 2.16 kg loading), 6 g/10 min.; melting point (Tm), 127° C.] (hereinafter referred to as HDPE-1),

55 parts by weight of oil-extended .ethylene/propylene/5-ethylidene-2-norbornene copolymer rubber [ethylene content, 78 mol %; propylene content, 22 mol %; iodine value, 13; Mooney viscosity [ML₁₊₄ (100° C.)], 74; the amount of an oil extender, 40 parts by weight of paraffin-based process oil (trade name: PW-380, manufactured by Idemitsu Kosan Co., Ltd.) based on 100 parts by weight of the rubber] (referred to hereinafter as EPT-2) as a rubber component,

30 parts by weight of a propylene/ethylene/1-butene terpolymer [MFR (ASTM D 1238, 230° C., 2.16 kg loading), 7.0 g/10 min.; melting point (Tm), 136° C.] (hereinafter referred to as PP-1) as polypropylene,

0.1 part by weight of a, phenol-based antioxidant [trade name: IRGANOX 1010, manufactured by Nihon Ciba-Geigy K.K.] as an antioxidant,

0.1 part by weight of a diazo-based weathering stabilizer [trade name: Tinubine 326, manufactured by Nihon Ciba-Geigy K.K.] as a weathering stabilizer,

0.08 part by weight of an organic peroxide [trade name: Perhexa 25B, manufactured by NOF Corporation] as a crosslinking agent, and

0.06 part by weight of divinyl benzene (DVB) as a crosslinking aid were mixed sufficiently in a Henschel mixer and granulated by an extruder [product number TEM-50; L/D=40; cylinder temperature: C1 to C2, 120° C.; C3 to C4, 140° C.; C5 to C6, 180° C.; C7 to C8, 200° C.; C9 to C12, 220° C.; dice temperature, 210° C.; number of revolutions of a screw, 200 rpm; output rate, 40 kg/h, manufactured by Toshiba Machine Co., Ltd.] while 20 parts by weight of paraffin-based process oil [trade name: PW-380, manufactured by Idemitsu Kosan Co., Ltd.] was injected into a cylinder, to give pellets of thermoplastic elastomer (thermoplastic elastomer 1).

### Reference Example 3

70 parts by weight of oil-extended ethylene/propylene/5-ethylidene-2-norbornene copolymer rubber (EPT-2) as a rubber component,

30 parts by weight of a propylene/ethylene/1-butene terpolymer [MFR (ASTM D 1238, 230° C., 2.16 kg loading), 7.0 g/10 min.; melting point (Tm), 136° C.] (hereinafter referred to as PP-1) as polypropylene,

0.1 part by weight of a phenol-based antioxidant [trade name: IRGANOX 1010, manufactured by Nihon Ciba-Geigy K.K.] as an antioxidant,

0.1 part by weight of a diazo-based weathering stabilizer [tradename: Tinubine 326, manufactured by Nihon Ciba-Geigy K.K.] as a weathering stabilizer,

0.32 part by weight of an organic peroxide [trade name: Perhexa 25B, manufactured by NOF Corporation] as a crosslinking agent, and

0.24 part by weight of divinyl benzene (DVB) as a crosslinking aid were mixed sufficiently in a Henschel mixer and granulated by an extruder [product number TEM-50; L/D=40; cylinder temperature: C1 to C2, 120° C.; C3 to C4, 140° C.; C5 to C6, 180° C.; C7 to C8, 200° C.; C9 to C12, 220° C.; dice temperature, 210° C.; number of revolutions of a screw, 200 rpm; output rate, 40 kg/h, manufactured by Toshiba Machine Co., Ltd.] while 20 parts by weight of paraffin-based process oil [trade name: PW-380, manufactured by Idemitsu Kosan Co., Ltd.] was injected into a cylinder, to give pellets of thermoplastic elastomer (thermoplastic elastomer 2).

### Example 1

The physical properties of the vulcanized rubber molded product 1 and thermoplastic elastomer 1 are shown in Table 1.

The thermoplastic elastomer 1 was formed such that in the stage of injection molding, it was melt-bonded to, a cut section of the vulcanized rubber molded product 1 in a 100-ton injection molding machine. The resulting molded product was examined in the following tensile peel strength test.

<Tensile Peel Strength Test of the Molded Product>

The molded product comprising the molded product of vulcanized rubber joined to the molded product consisting of thermoplastic elastomer, that is, the weather strip in FIG. 1, was examined in a tensile test by pulling it at a tensile rate of 200 mm/min. while holding two positions between which the connector was sandwiched, and after the test, whether the resulting section was due to matrix breakage or interfacial release was confirmed by observation, and the ratio of the thermoplastic elastomer remaining on the peel section to the adhesive surface was indicated as degree of breakage of matrix. The results are shown in Table 1.

### Example 2

A vulcanized rubber molded product 2 was obtained in the same manner as in Reference Example 1 except that EPT-3 below was used in place of EPT-1. The same procedure as in Example 1 was conducted except that a vulcanized rubber molded product 2 was used in place of the vulcanized rubber molded product in Example 1. The evaluation results are shown in Table 1.

EPT-3

A vulcanized rubber molded product 2 was obtained in the same manner as in Reference Example 1 except that a rubber composition (hereinafter referred to as EPT-3) containing 100 parts by weight of oil-extended ethylene/propylene/5-ethylidene-2-norbornene copolymer rubber (ethylene content, 68 mol %; propylene content, 32 mol %;. iodine value, 12; the amount of an oil extender, 10 parts by weight of paraffin-based process oil (trade name: PW-380, manufactured by Idemitsu Kosan. Co.; Ltd.) based on 100 parts by weight of the rubber); Mooney viscosity [ML₁₊₄ (125° C.)], 63), 12 parts by weight of low-density polyethylene (MFR at 190° C. under a loading of 2.16 kg=1.6 g/10 min.; density 0.920 g/cm³) and 8 parts by weight of linear low-density polyethylene (MFR at 190° C. under a loading of 2.16 kg=1.6 g/10 min.; density 0.921 g/cm³) was used.

### Comparative Example 1

An ethylene/propylene/5-ethylidene-2-norbornene copolymer rubber (ethylene content, 68 mol %; propylene content, 32 mol %; iodine value, 12; the amount of an oil extender, 10 parts by weight of paraffin-based process oil (tradename: PW-380, manufactured by Idemitsu Kosan Co., Ltd.) based on 100 parts by weight of the rubber; Mooney viscosity [ML₁₊₄ (125° C.)], 63) was used in place of EPT-1 in Reference Example 1, and FEF-grade carbon black [trade name: Asahi #60G, manufactured by Asahi Carbon Co., Ltd.] was used in an amount of 185 parts by weight, to give a vulcanized rubber molded product 3. The procedure was conducted in the same manner as in Example 1 except that the vulcanized rubber molded product 3 was used in place of the vulcanized rubber molded product 1 in Example 1. The evaluation results are shown in Table 1.

### Comparative Example 2

The procedure was carried out in the same manner as in Example 1 except that the thermoplastic elastomer 2 in Reference Example 3 was used in place of the thermoplastic elastomer 1 in Example 1. The evaluation results are shown in Table 1.

### Comparative Example 3

The procedure was carried out in the same manner as in Comparative Example 2 except that the vulcanized rubber molded product 2 was used in place of the vulcanized rubber molded product 1 in Comparative Example 2. The evaluation results are shown in Table 1.

### Comparative Example 4

The procedure was carried out in the same manner as in Comparative Example 1 except that the thermoplastic elastomer 2 was used in place of the thermoplastic elastomer 1 used in Comparative Example 1. The results are shown in Table 1.

### Example 3

85 parts by weight of pellets of the thermoplastic elastomer 2 were blended with 15 parts by weight of linear low-density polyethylene (MFR at 190° C. under a loading of 2.16 kg=8 g/10 min.; density 0.920 g/cm³) in a TEM extruder to give thermoplastic elastomer 3. Then, the procedure was carried out in the same manner as in Example 2 except that the thermoplastic elastomer 3 was used in place of the thermoplastic elastomer 1 in Example 2. The evaluation results are shown in Table 1.

### Comparative Example 5

The procedure was carried out in the same manner as in Comparative Example 1 except that the thermoplastic elastomer was used in place of the thermoplastic elastomer 1 used in comparative Example 1. The results are shown in Table 1.

TABLE 1a

| Note | | | | Example 1 | Example 2 | Example 3 |
|---|---|---|---|---|---|---|
| Vulcanized | Vulcanized | Olefin resin | Wt % | 4.8 PP | | |
| rubber molded | rubber molded | content | | | | |
| product | product 1 | | | | | |
| | Vulcanized | | Wt % | | 4.8 PE | 4.8 PE |
| | rubber molded | | | | | |
| | product 2 | | | | | |
| | Vulcanized | | Wt % | | | |
| | rubber molded | | | | | |
| | product 3 | | | | | |
| Thermoplastic | Thermoplastic | Gel fraction | wt % | 8 | 8 | |
| elastomer | elastomer 1 | Addition of | — | no | no | |
| | | non-crosslinked | | | | |
| | | ethylene-based | | | | |
| | | component | | | | |
| | Thermoplastic | Gel fraction | wt % | | | |
| | elastomer 2 | Addition of | — | | | |
| | | non-crosslinked | | | | |
| | | ethylene-based | | | | |
| | | component | | | | |
| | Thermoplastic | Gel fraction | wt % | | | 28 |
| | elastomer 3 | Addition of | — | | | yes |
| | | non-crosslinked | | | | |
| | | ethylene-based | | | | |
| | | component | | | | |
| | | Amount of | wt % | | | 15 |
| | | Addition of | | | | |
| | | non-crosslinked | | | | |
| | | ethylene-based | | | | |
| | | component | | | | |

| | | | | | |
|---|---|---|---|---|---|
| Physical properties of vulcanized | Hardness | Shore A | 77 | 79 | 79 |
| rubber molded product | Tensile strength | MPa | 12.9 | 11.4 | 11.4 |
| | Elongation | % | 290 | 270 | 270 |
| Physical properties of | MFR | g/10 min | 1.2 | 1.2 | 4.2 |
| thermoplastic elastomer | Hardness | Shore A | 84 | 84 | 85 |
| | Tensile strength | MPa | 6.7 | 6.7 | 8.9 |
| | Elongation | % | 700 | 700 | 600 |
| Adhesion between vulcanized | Adhesion peel | MPa | 46 | 45 | 46 |
| rubber molded product and | strength | | | | |
| thermoplastic elastomer | Form of breakage | — | matrix | matrix | matrix |
| | upon release | | breakage | breakage | breakage |
| | Degree of | % | 100 | 80 | 80 |
| | breakage of matrix | | | | |

TABLE 1b

| | | | | Comparative | Comparative | Comparative | Comparative | Comparative |
|---|---|---|---|---|---|---|---|---|
| Note | | | | Example 1 | Example 2 | Example 3 | Example 4 | Example 5 |
| Vulcanized | Vulcanized | Olefin resin | Wt % | | 4.8 PP | | | |
| rubber | rubber molded | content | | | | | | |
| molded | product 1 | | | | | | | |
| product | Vulcanized | | Wt % | | | 4.8 PE | | |
| | rubber molded | | | | | | | |
| | product 2 | | | | | | | |
| | Vulcanized | | Wt % | 0 | | | 0 | |
| | rubber molded | | | | | | | |
| | product 3 | | | | | | | |
| Thermo- | Thermoplastic | Gel fraction | wt % | 8 | | | | |
| plastic | elastomer 1 | Addition of | — | no | | | | |
| elastomer | | non-crosslinked | | | | | | |
| | | ethylene-based | | | | | | |
| | | component | | | | | | |
| | Thermoplastic | Gel fraction | wt % | | 37 | 37 | 37 | |
| | elastomer 2 | Addition of | — | | no | no | no | |
| | | non-crosslinked | | | | | | |
| | | ethylene-based | | | | | | |
| | | component | | | | | | |
| | Thermoplastic | Gel fraction | wt % | | | | | 28 |
| | elastomer 3 | Addition of | — | | | | | yes |
| | | non-crosslinked | | | | | | |
| | | ethylene-based | | | | | | |
| | | component | | | | | | |
| | | Amount of | wt % | | | | | 15 |
| | | Addition of | | | | | | |
| | | non-crosslinked | | | | | | |
| | | ethylene-based | | | | | | |
| | | component | | | | | | |

| | | | | | | | |
|---|---|---|---|---|---|---|---|
| Physical properties of | Hardness | Shore A | 77 | 77 | 79 | 77 | 77 |
| vulcanized rubber molded | Tensile | MPa | 12.2 | 12.9 | 11.4 | 12.2 | 12.2 |
| product | strength | | | | | | |
| | Elongation | % | 200 | 290 | 270 | 200 | 200 |
| Physical properties of | MFR | g/10 min | 1.2 | 3.4 | 3.4 | 3.4 | 4.2 |
| thermoplastic elastomer | Hardness | Shore A | 84 | 83 | 83 | 83 | 85 |
| | Tensile | MPa | 6.7 | 8.1 | 8.1 | 8.1 | 8.9 |
| | strength | | | | | | |
| | Elongation | % | 700 | 610 | 610 | 610 | 600 |
| Adhesion between vulcanized | Adhesion | MPa | 41 | 43 | 43 | 40 | 42 |
| rubber molded product and | peel | | | | | | |
| thermoplastic elastomer | strength | | | | | | |
| | Form of | — | matrix | Interfacial | Interfacial | Interfacial | matrix |
| | breakage | | breakage | breakage | breakage | breakage | breakage |
| | upon | | | | | | |
| | release | | | | | | |
| | Degree of | % | 50 | 0 | 0 | 0 | 40 |
| | breakage | | | | | | |
| | of matrix | | | | | | |

1. A molded composite comprising (1) a vulcanized rubber molded product containing 2 to 10 wt % olefinic resin having a crystallinity of 10% or more as determined by a differential scanning calorimeter (DSC) joined to (2) a molded product comprising a thermoplastic elastomer containing 10 wt % or more olefinic resin having a crystallinity of 10% or more as determined by a differential scanning calorimeter (DSC), having a gel fraction of 30 wt % or less, and having an islands-sea structure.

2. The molded composite according to claim 1, wherein the molded composite is used in an interior or exterior decorative material for an automobile.

3. The molded composite according to claim 2, wherein the interior or exterior decorative material for an automobile is a weather strip material.
